(19) United States
(12) Patent Application Publication
(10) Pub. No.: US 2006/0116124 A1
(43) Pub. Date: Jun. 1, 2006

(54) Method for paging a mobile unit based upon previous cell locations

(76) Inventors: Kenneth W. Del Signore, North Aurora, IL (US); Jenq-Yann Wellington Ku, Westmont, IL (US); Carl Joseph Spies, LaFox, IL (US)

Correspondence Address: Lucent Technologies Inc.;Docket Administrator, Room 3J-219, 101 Crawfords Corner Road, Holmdel, NJ, 07733-3030, US

(21) Appl. No.: 11/000,377

(22) Filed: Nov. 30, 2004

(51) Int. Cl. H04Q 7/20

(52) U.S. Cl. 455/435.1; 455/433

(57) ABSTRACT

The present invention provides a method for paging a mobile unit based upon previous cell locations of the mobile unit. When a request to page a mobile unit is received, an MSC retrieves a paging record associated with the mobile unit. The paging record includes a list of cells that the mobile unit has visited within a predetermined period of time. The MSC sends a paging message for the mobile unit to the list of cells in the paging record.

### FIELD OF THE INVENTION

The present invention relates generally to mobile communication systems, and more particularly to a method for paging a mobile unit in a mobile communication system.

### BACKGROUND OF THE INVENTION

In mobile or wireless communication systems, mobile units have the capability to roam within the wireless communication system. When the wireless communication system receives a call request for a mobile unit, the communication system has to locate the mobile unit in order to complete the call.

Historically, when an incoming call arrived for a mobile phone, all of the cells in the entire MSC were paged in order to contact the mobile unit and deliver the call. The process of paging a mobile unit consumes many resources within the MSC. These resources include bandwidth over the paging channel, processor occupancy of internal network elements, and the bandwidth for signaling messages between those elements.

One proposed solution has been to broadcast paging messages to a narrow group of cells, and then broadcast to progressively larger groups in hope of eventually finding the mobile unit. Ideally, one would start with a very small number of cells, perhaps just a single cell, and then progressively widen the scope. Unfortunately, delivering a call to a mobile unit is time critical. Each paging attempt with an associated timer may take about five seconds. The calling party is likely to abandon the call before the mobile unit is found if too many paging attempts are necessary. Time is especially critical for push-to-talk applications.

If too few cells receive the page, one risks missing the mobile unit. If too many cells receive each page, resource shortages may ensue. There is currently no mechanism for determining the optimal location area size. Therefore, a need exists for a method for efficiently paging a mobile unit that allows for a decreased paging area but that does not consume an abundance of system resources.

### BRIEF SUMMARY OF THE INVENTION

The present invention provides a method for updating a paging record of a mobile unit. Each mobile unit that has registered with an MSC in the recent past will have an associated paging record. Each paging record includes a cell field, a last accessed field, a successful pages field, and a total pages field. The cell field includes an entry for each cell that has been accessed by the mobile unit within the predetermined time period. The last accessed field includes an entry that indicates the last time that the associated mobile unit was located within the corresponding cell, which is preferably updated each time the mobile unit sends a message to the MSC. The successful pages field is a field that includes a count of the number of successful paging attempts for the associated mobile unit while in the specified cell. The total pages field is a field that includes a count of the total number of pages made for the mobile unit in the associated cell.

Each time a mobile unit interacts with the MSC, the MSC updates the paging record for the mobile unit. An interaction includes any message sent from the mobile unit to the MSC, including registration messages, handoff messages, and any other messages sent from the mobile unit to the MSC via a base station.

The paging records are preferably updated to remove stale entries on a regular basis, such as nightly. A system value is set to a predetermined period of time, such as seven days. The MSC retrieves each paging record and extracts each cell entry from the paging record. The MSC goes through the paging record and extracts, one by one, the value from the last accessed field for each of the accessed cells in the paging record. The MSC determines if the cell in the current entry has been visited by the mobile unit within the predetermined time period. If so, the MSC leaves the cell entry in the paging record and extracts the next cell entry. If the cell has not been visited by the mobile unit within the time period, the MSC removes the cell entry from the paging record. In this manner, the cell is being removed from the paging list so that the removed cell will not be paged the next time the associated mobile unit receives a page request.

When a request is received at an MSC for a mobile unit, the MSC retrieves the paging record associated with the mobile unit. The MSC goes through the paging record and extracts the list of cells that the mobile unit has accessed and pages the cells that are listed in the paging record. Upon receiving a valid response from the paged mobile unit, the MSC completes the call.

### BRIEF DESCRIPTION OF THE SEVERAL VIEWS OF THE DRAWINGS

FIG. 1 depicts a cellular grid of a communication system and a group of visited cells in accordance with an exemplary embodiment of the present invention.

FIG. 2 depicts a paging record for a mobile unit in accordance with an exemplary embodiment of the present invention.

FIG. 3 depicts a flowchart of a method for updating a paging record of a mobile unit in accordance with an exemplary embodiment of the present invention.

FIG. 4 depicts a flowchart of a method for selectively paging a mobile unit in accordance with an exemplary embodiment of the present invention.

FIG. 5 depicts a flowchart of a method for updating a paging record of a mobile unit in accordance with an exemplary embodiment of the present invention.

### DETAILED DESCRIPTION OF THE INVENTION

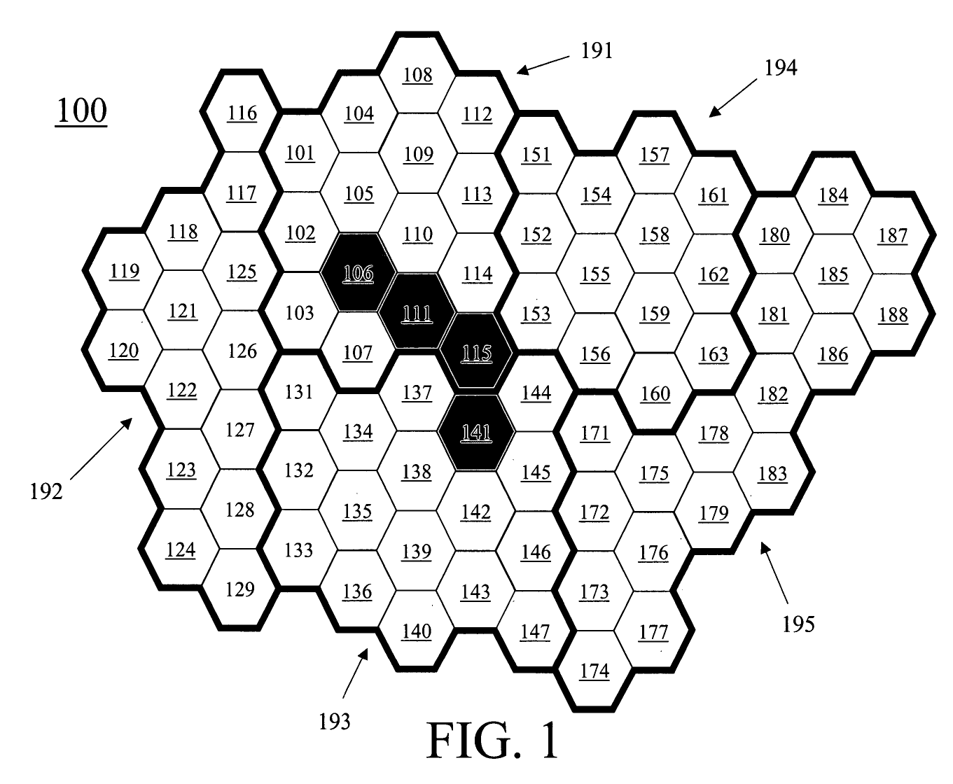

The present invention can be better understood with reference to FIGS. 1 through 5. FIG. 1 depicts a cellular grid 100 of a communication system and a group of visited cells in accordance with an exemplary embodiment of the present invention.

Cellular grid 100 depicts cells that are under the control of a Mobile Switching Center (MSC), not pictured. Each of these zones includes a plurality of cells and is commonly referred to as a location area (LA). LA 191 comprises cells 101 through 115, LA 192 comprises cells 116 through 129, LA 193 comprises cells 131 through 147, LA 194 comprises cells 151 through 163, and LA 195 comprises cells 171 through 188.

The wireless communication system includes an MSC and a plurality of base stations. In the exemplary embodiment depicted in FIG. 1, the MSC controls all base stations and all cells depicted. Each base station transmits and receives signals to and from a mobile unit located within their cell.

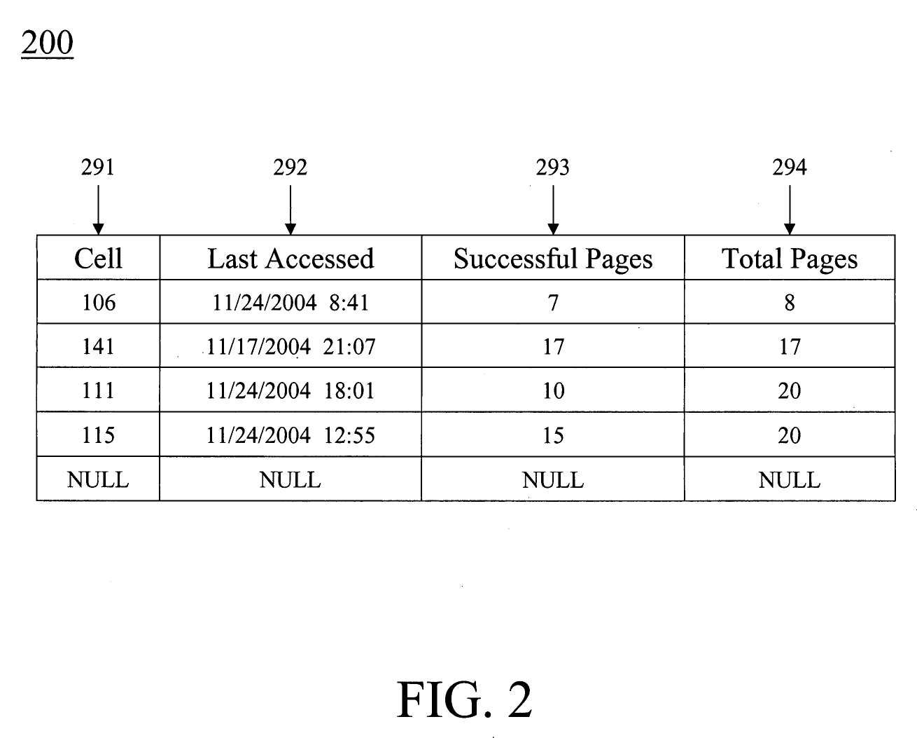

FIG. 2 depicts a paging record 200 for a mobile unit in accordance with an exemplary embodiment of the present invention. Each mobile unit that has registered with the MSC in the recent past will have an associated paging record. Paging record 200 includes cell field 291, last accessed field 292, successful pages field 293, and total pages field 294.

Cell field 291 includes an entry for each cell that has been accessed by the mobile unit within the predetermined time period. Each cell field preferably includes the cell number of a cell, or a NULL value if there is no cell entry.

Last accessed field 292 includes an entry that indicates the last time that the associated mobile unit was located within the corresponding cell. In an exemplary embodiment, each last accessed field is updated each time the mobile unit sends a message to the MSC while within a cell.

Successful pages field 293 is a field that includes a count of the number of successful paging attempts for the associated mobile unit while in the specified cell.

Total pages field 294 is a field that includes a count of the total number of pages made for the mobile unit in the associated cell.

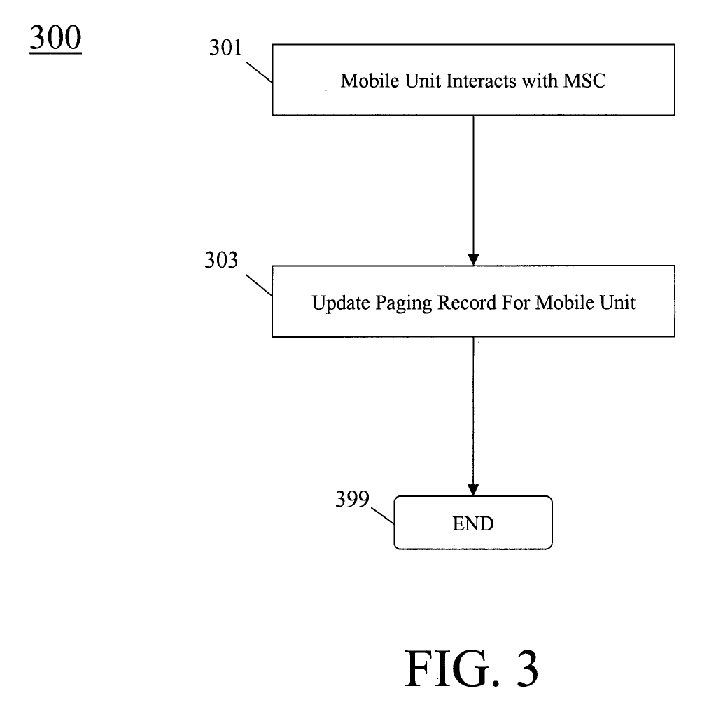

FIG. 3 depicts a flowchart 300 of a method for updating a paging record of a mobile unit in accordance with an exemplary embodiment of the present invention.

A mobile unit interacts (301) with an MSC. The interaction includes any message sent from the mobile unit to the MSC. By receiving a message from the mobile unit that is located within a particular cell, the MSC knows that the mobile unit is currently located within the coverage area of that cell. The interactions include registration messages, handoff messages, and any other messages sent from the mobile unit to the MSC via a base station.

The MSC updates (303) the paging record for the mobile unit. In an exemplary embodiment, the MSC accesses the paging record associated with the mobile unit and determines if an entry exists for the current cell. If an entry exists for the current cell, the entry is overwritten with the current date and time. If an entry does not exist for the current cell, the MSC creates a new entry for the current cell and writes the date and time extracted from the message into the last accessed field. The process then ends (399).

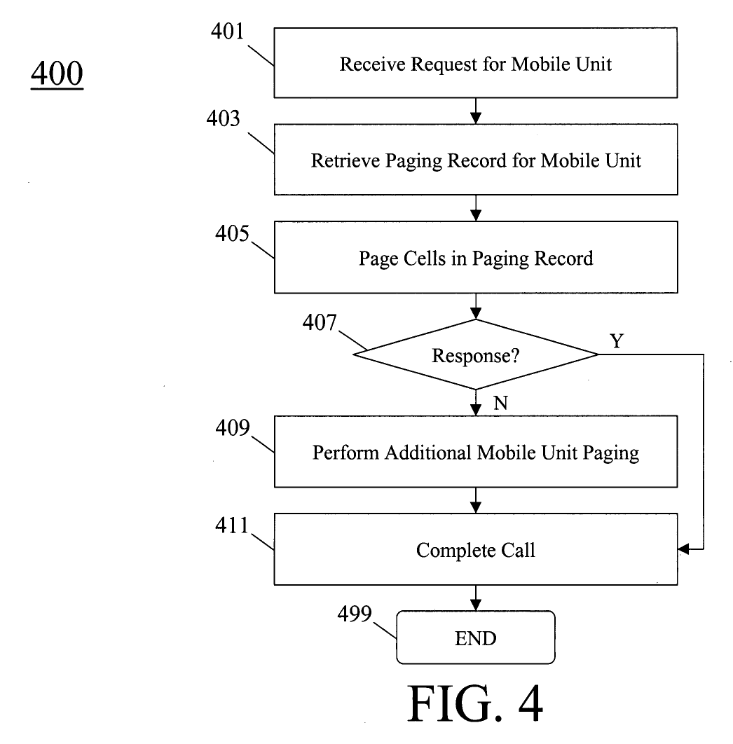

FIG. 4 depicts a flowchart 400 of a method for selectively paging a mobile unit in accordance with an exemplary embodiment of the present invention.

The MSC receives (401) a request for a mobile unit. The request is any message that desires to locate the mobile unit. In an exemplary embodiment, the request is a call request received by the MSC requesting a call between the caller and the mobile unit.

The MSC retrieves (403) the paging record associated with the mobile unit. The MSC utilizes an identifier associated with the called mobile unit to determine which paging record to retrieve. In an exemplary embodiment, the MSC utilizes the International Mobile Subscriber Identity (IMSI), the Mobile Identification Number (MIN), the electronic serial number (ESN), or the Mobile Equipment IDentifier (MEID) of the mobile unit to identify the mobile unit.

In an exemplary embodiment, the MSC goes through the paging record and extracts the list of cells that the mobile unit has accessed. In an exemplary embodiment, the MSC extracts all cells from the paging record. In a further exemplary embodiment, the MSC checks to see if each cell has been accessed within a predetermined time period.

The MSC pages (405) the cells that are listed in the paging record. In an exemplary embodiment, the MSC only pages the cells that have a paging success rate that exceeds a predetermined ratio. The paging success rate is calculated by dividing the value in successful pages field 293 by the value in total pages field 294. This allows the MSC to only page the cells that have had a high success rate in the past, thereby increasing the efficiency of system resources when paging a mobile unit.

For example, referring to FIG. 2, assume that the process is run on Nov. 30, 2004, and that the predetermined time period is seven days. Also assume that the paging success rate is 75%. The MSC retrieves the last accessed date and time for cell 106, and determines that cell 106 has been accessed by the mobile unit within the predetermined time period. The MSC calculates the paging success rate for cell 106, which equals the successful pages divided by the total pages, which in this example is 87.5%. Since the mobile unit has accessed cell 106 within the time period and the success rate of pages exceeds the paging success rate, the MSC will page the mobile unit in cell 106.

Continuing with this example with the data in FIG. 2, the MSC will not page the mobile unit in cell 141, since the last access by the mobile unit is greater than the predetermined time period of seven days. The MSC will not page the mobile unit in cell 111, even though the mobile unit accessed cell 111 within the predetermined time period, because the success rate of 50% is less than the paging success rate threshold of 75%. The MSC will page the mobile unit in cell 115 because the mobile unit accessed cell 115 within the predetermined time period, and the paging success rate is equal to the success rate threshold of 75%.

The MSC determines (407) if it has received a valid response from the paged mobile unit. If the MSC has received a valid page response from the mobile unit, the MSC completes (411) the call. In an exemplary embodiment, the valid page response from the mobile unit will trigger the process of FIG. 3.

If the MSC does not receive a valid response to the page, the MSC performs (409) additional paging of the mobile unit. Upon locating the mobile unit, the MSC completes (411) the call. The process then ends (499).

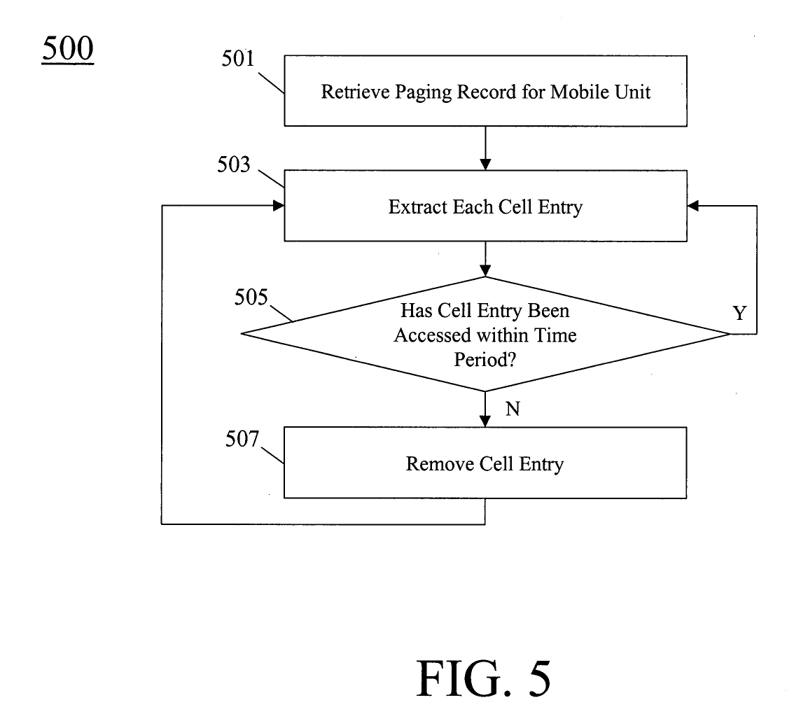

FIG. 5 depicts a flowchart 500 of a method for updating a paging record of a mobile unit in accordance with an exemplary embodiment of the present invention. In an exemplary embodiment, a system administrator selects a predetermined period of time, such as seven days. A system value is set to this predetermined value. In an exemplary embodiment, the MSC runs an audit during a time of low system activity, such as during the night. The audit will perform the steps depicted in FIG. 5 to remove outdated or stale entries from the paging record.

The MSC retrieves (501) a paging record for a mobile unit. The MSC utilizes an identifier associated with the called mobile unit to determine which paging record to retrieve.

The MSC extracts (503) each cell entry from the paging record. In an exemplary embodiment, the MSC goes through the paging record and extracts, one by one, the value from the last accessed field for each of the accessed cells in the paging record.

The MSC determines (505) if the cell in the current entry has been visited by the mobile unit within the predetermined time period. In an exemplary embodiment, the MSC compares the current date and time to the value retrieved from the last accessed field. If the difference between these two fields is less than the predetermined time period, the MSC leaves the cell entry in the paging record and returns to step 503 to extract the next cell entry.

If the cell has not been visited by the mobile unit within the time period as determined at step 505, the MSC removes (507) the cell entry from the paging record. This is preferably done by replacing the cell value and the last accessed value with a NULL value. In this manner, the cell is being removed from the paging list so that the removed cell will not be paged the next time the associated mobile unit receives a page request.

The process continues until all cells that have been accessed by the mobile unit are evaluated to determine if the cell is still fresh and should be paged when a request comes in for the associated mobile unit.

While this invention has been described in terms of certain examples thereof, it is not intended that it be limited to the above description, but rather only to the extent set forth in the claims that follow.

We claim:

1. A method for paging a mobile unit comprising:
receiving a request to page a mobile unit;
retrieving a paging record associated with the mobile unit, the paging record including a list of cells that the mobile unit has visited within a predetermined period of time; and
sending a paging message for the mobile unit to the list of cells in the paging record.

2. A method for paging a mobile unit in accordance with claim 1, the method further comprising the step of completing a call to the mobile unit.

3. A method for paging a mobile unit in accordance with claim 1, the method further comprising the step of determining a paging success rate.

4. A method for paging a mobile unit in accordance with claim 3, wherein the step of determining a paging success rate comprises dividing the number of successful pages by the total number of pages.

5. A method for paging a mobile unit in accordance with claim 3, wherein the step of determining a paging success rate comprises comparing the paging success rate to a predetermined paging success ratio.

6. A method for updating a paging record associated with a mobile unit comprising:
receiving a message from a mobile unit at an MSC; and
updating a paging record associated with the mobile unit.

7. A method for updating a paging record associated with a mobile unit in accordance with claim 6, wherein the step of receiving a message from a mobile unit comprises receiving a registration message from the mobile unit.

8. A method for updating a paging record associated with a mobile unit in accordance with claim 6, wherein the step of receiving a message from a mobile unit comprises receiving a handoff message from the mobile unit.

9. A method for updating a paging record associated with a mobile unit in accordance with claim 6, wherein the step of updating a paging record associated with the mobile unit comprises adding a cell entry in the paging record.

10. A method for updating a paging record associated with a mobile unit in accordance with claim 9, the method further comprising the step of adding an entry in a last accessed field associated with the cell entry.

11. A method for updating a paging record associated with a mobile unit in accordance with claim 6, wherein the step of updating a paging record associated with the mobile unit comprises updating a last accessed field in the paging record.

12. A method for updating a paging record associated with a mobile unit comprising:
retrieving a paging record associated with a mobile unit, the paging record including a list of cell entries, each of the cell entries including a cell identifier and an indication of the last time the mobile unit accessed the cell;
determining if the cell entry is out of date; and
removing the cell entry if the cell entry is out of date.

13. A method for updating a paging record associated with a mobile unit in accordance with claim 12, the method further comprising the step of calculating a time since the last access by the mobile unit.

14. A method for updating a paging record associated with a mobile unit in accordance with claim 13, wherein the step of calculating a time since the last access by the mobile unit comprises comparing the current date and time to the indication of the last time the mobile unit accessed the cell.

15. A method for updating a paging record associated with a mobile unit in accordance with claim 13, wherein the step of determining if the cell entry is out of date comprises comparing time since the last access by the mobile unit to a predetermined time period.
